(19) United States
(12) Patent Application Publication
(10) Pub. No.: US 2013/0215127 A1
(43) Pub. Date: Aug. 22, 2013

(54) METHOD, APPARATUS AND COMPUTER PROGRAM PRODUCT FOR MANAGING RENDERING OF CONTENT

(71) Applicant: Chethan Palakshamurthy, Bangalore (IN)

(72) Inventor: Chethan Palakshamurthy, Bangalore (IN)

(73) Assignee: NOKIA CORPORATION, Espoo (FI)

(21) Appl. No.: 13/590,559

(22) Filed: Aug. 21, 2012

(30) Foreign Application Priority Data
Aug. 31, 2011 (IN) 3011/CHE/2011

(51) Int. Cl. G06T 1/20

(52) U.S. Cl. CPC G06T 1/20
USPC 345/522

(57) ABSTRACT

In accordance with an example embodiment, a method, apparatus, and computer program product is provided. The method comprises determining a state of a rendering component, determining a status of hardware rendering resources, and facilitating a hardware rendering or a software rendering of content associated with the rendering component based on the state of the rendering component and the status of the hardware rendering resources. The apparatus comprises at least one processor and at least one memory comprising computer program code, configured to, cause the apparatus at least to perform: determining a state of a rendering component; determining a status of hardware rendering resources; and facilitating a hardware rendering or a software rendering of content associated with the rendering component based on the state of the rendering component and the status of the hardware rendering resources.

### TECHNICAL FIELD

Various implementations relate generally to method, apparatus, and computer program product for hardware and software rendering of content.

### BACKGROUND

Various electronic devices such as mobile phones, personal computers, and the like, are capable of running computer graphics intensive applications that involves rendering of graphical content. As the demand for the applications involving rendering of graphical content has increased, electronic devices use dedicated hardware such as graphic processing unit to accelerate the rendering process. However, managing the usage of graphic processing unit in the optimized manner is always a challenge. For instance, multiple graphic applications may run simultaneously in the electronic device, and in such cases, it becomes important to optimize usage of rendering resources for performing software rendering or hardware rendering of content associated with these applications.

### SUMMARY OF SOME EMBODIMENTS

Various aspects of examples embodiments are set out in the claims.

In a first aspect, there is provided a method comprising: determining at least a state of a rendering component; determining at least a status of hardware rendering resources; and facilitating a hardware rendering or a software rendering of content associated with the rendering component based at least in part on the state of the rendering component and the status of the hardware rendering resources.

In a second aspect, there is provided an apparatus comprising: at least one processor; and at least one memory comprising computer program code, the at least one memory and the computer program code configured to, with the at least one processor, cause the apparatus at least to perform: determining at least a state of a rendering component; determining at least a status of hardware rendering resources; and facilitating a hardware rendering or a software rendering of content associated with the rendering component based at least in part on the state of the rendering component and the status of the hardware rendering resources.

In a third aspect, there is provided an apparatus comprising: a graphic processing unit configured to perform hardware rendering of content; a central processing unit configured to provide software rendering of content; and at least one rendering component, configured to, with the graphic processing unit and the central processing unit, to cause the apparatus at least in part to, perform facilitating one of the hardware rendering or the software rendering of the content associated with the at least one rendering component based on a state of the at least one rendering component and status of hardware rendering resources in the apparatus.

In a fourth aspect, there is provided a computer program product comprising at least one computer-readable storage medium, the computer-readable storage medium comprising a set of instructions, which, when executed by one or more processors, cause an apparatus to at least perform: determining at least a state of a rendering component; determining at least a status of hardware rendering resources; and facilitating a hardware rendering or a software rendering of content associated with the rendering component based at least in part on the state of the rendering component and the status of the hardware rendering resources.

In a fifth aspect, there is provided an apparatus comprising: means for determining at least a state of a rendering component; means for determining at least a status of hardware rendering resources; and means for facilitating a hardware rendering or a software rendering of content associated with the rendering component based at least in part on the state of the rendering component and the status of the hardware rendering resources.

In a sixth aspect, there is provided a computer program comprising program instructions which when executed by an apparatus, cause the apparatus to: determine at least a state of a rendering component; determine at least a status of hardware rendering resources; and facilitate a hardware rendering or a software rendering of content associated with the rendering component based at least in part on the state of the rendering component and the status of the hardware rendering resources.

### BRIEF DESCRIPTION OF THE FIGURES

Various embodiments are illustrated by way of example, and not by way of limitation, in the figures of the accompanying drawings in which:

FIG. 1 illustrates a device in accordance with an example embodiment;

FIG. 2 illustrates an apparatus for managing rendering of content in accordance with an example embodiment;

FIG. 3 illustrates an apparatus for managing rendering of content in accordance with another example embodiment;

FIG. 4 illustrates a method for managing rendering of content in an apparatus in accordance with an example embodiment; and

FIG. 5 illustrates a method for managing rendering of content in an apparatus in accordance with another example embodiment.

### DETAILED DESCRIPTION

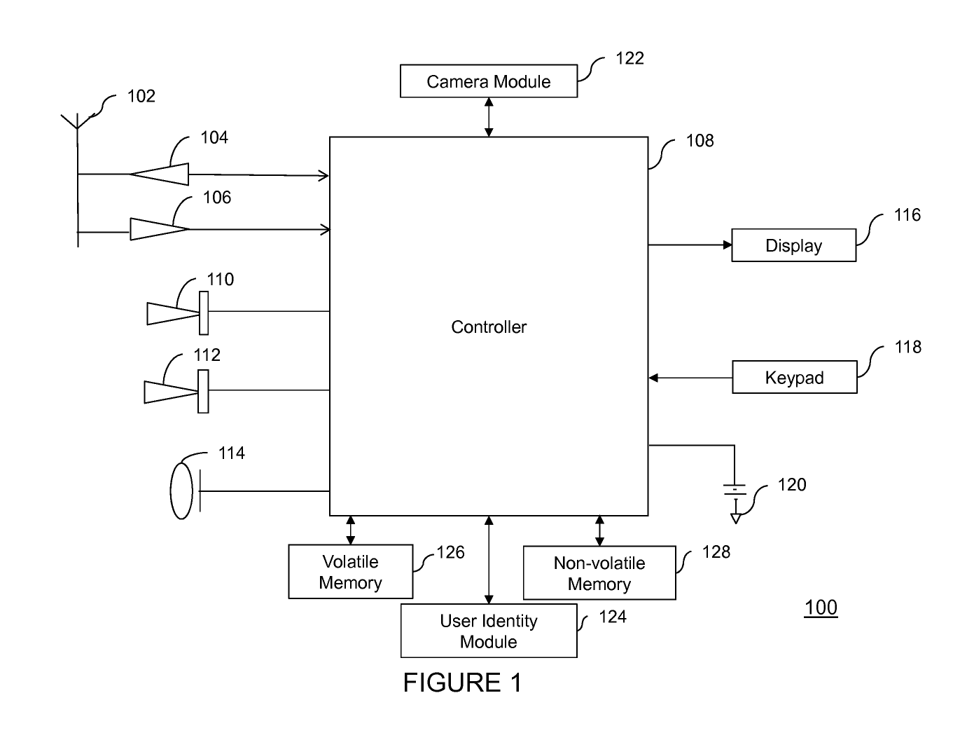

Example embodiments and their potential effects are understood by referring to FIGS. 1 through 5 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA 1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as include Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means for capturing an image, video and/or audio for storage, display or transmission. In an example embodiment in which the media capturing element is a camera module 122, the camera module 122 may include a digital camera capable of forming a digital image file from a captured image. As such, the camera module 122 includes all hardware, such as a lens or other optical component(s), and software for creating a digital image file from a captured image. Alternatively, the camera module 122 may include the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format.

For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

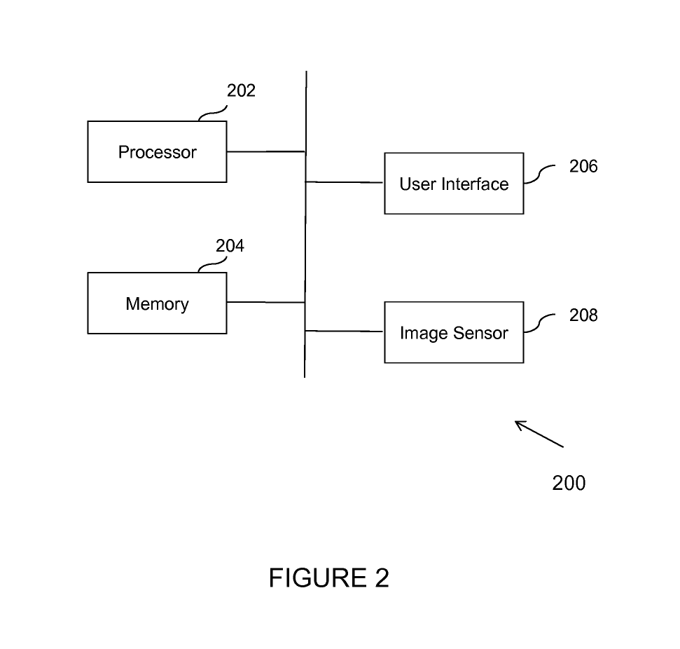

FIG. 2 illustrates an apparatus 200 for managing rendering of content in accordance with an example embodiment. The apparatus 200 may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. In an example embodiment, the apparatus 200 is a mobile phone, which may be an example of a communication device. Alternatively or additionally, embodiments may be employed on a combination of devices including, for example, those listed above. Accordingly, various embodiments may be embodied wholly at a single device, for example, the device 100 or in a combination of devices. It should be noted that some devices or elements described below may not be mandatory and thus some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data comprising media content for processing by the processor 202. Additionally or alternatively, the memory 204 may be configured to store instructions for execution by the processor 202.

An example of the processor 202 may include the controller 108. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), a graphic processing unit (GPY), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206 include, but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the apparatus 200 may include an electronic device. Some examples of the electronic device include communication device, media capturing device with communication capabilities, computing devices, and the like. Some examples of the communication device may include a mobile phone, a personal digital assistant (PDA), and the like. Some examples of computing device may include a laptop, a personal computer, and the like. In an example embodiment, the communication device may include a user interface, for example, the UI 206, having user interface circuitry and user interface software configured to facilitate a user to control at least one function of the communication device through use of a display and further configured to respond to user inputs. In an example embodiment, the communication device may include a display circuitry configured to display at least a portion of the user interface of the communication device. The display and display circuitry may be configured to facilitate the user to control at least one function of the communication device.

In an example embodiment, the communication device may be embodied as to include a transceiver. The transceiver may be any device operating or circuitry operating in accordance with software or otherwise embodied in hardware or a combination of hardware and software. For example, the processor 202 operating under software control, or the processor 202 embodied as an ASIC or FPGA specifically configured to perform the operations described herein, or a combination thereof, thereby configures the apparatus or circuitry to perform the functions of the transceiver. The transceiver may be configured to receive media content. Examples of media content may include audio content, video content, data, and a combination thereof.

In an example embodiment, the communication device may be embodied as to include an image sensor, such as an image sensor 208. The image sensor 208 may be in communication with the processor 202 and/or other components of the apparatus 200. The image sensor 208 may be in communication with other imaging circuitries and/or software, and is configured to capture digital images or to make a video or other graphic media files. The image sensor 208 and other circuitries, in combination, may be an example of the camera module 122 of the device 100.

In an example embodiment, the processor 202 is configured to, with the content of the memory 204, and optionally with other components described herein, to cause the apparatus 200 to managing rendering of content associated with rendering components in the apparatus 200. In an example embodiment, the rendering components refer to any software program/instructions, tools or middleware components utilized for displaying any content such as video, graphics, animation, audio-visual content, image, and the like. Some examples of the rendering components non-exhaustively include flash plugin, media players, gaming applications, web browsers and various widgets or tools. For instance, a flash plugin such as adobe® flash plugin, or a Microsoft Silverlight® may operate with web browser to render content such as video or animation, or a media player such as real player™ may be utilized for playing streaming audio and video content. Similarly, there may be gaming rendering components for providing two-dimensional (2D) and/or three-dimensional (3D) graphic rendering.

In certain example embodiments, rendering of the content may be facilitated by way of software rendering or hardware rendering. In some example embodiments, the hardware rendering is aided by specialized graphic hardware, such as graphic processing unit (GPU), and the software rendering is performed by a central processing unit (CPU) present in or accessible to the apparatus 200. In some example embodiments, the functionalities of the GPU and the CPU are integrated in the processor 202. In such example embodiments, the processor 202 along with the memory 204 and other components is configured to facilitate hardware rendering or the software rendering of content in the apparatus 200.

The apparatus 200 may receive the content from internal memory such as hard drive, random access memory (RAM) of the apparatus 200, or from external storage medium such as digital versatile disk (DVD), compact disk (CD), flash drive, memory card, or from external storage locations through the Internet, Bluetooth®, and the like. The apparatus 200 may also receive the content from the memory 204 or directly from received and/or instantaneously captured by the image sensor 208 and/or other circuitries.

In an example embodiment, the processor 202 is configured to, with the content of the memory 204, and optionally with other components described herein, to cause the apparatus 200 to determine a state of a rendering component. At an instance, the rendering component may have a state of a plurality of states. For example, at certain instances, the rendering component may operate in one or more of a foreground UI/window or in one or more of a background UI/window in the apparatus 200. Such instances of the rendering component may be termed as one or more of a foreground state or a background state of the rendering component, respectively. For instance, if a rendering component such as a media player is currently utilized to access a file (for example, ‘file1.avi’) and the ‘file1.avi’ is accessed and is displayed on the display of the UI 206 (foreground window), its state may be termed as the foreground state. In an example embodiment, the background state of the rendering component refers to rendering component running in the background window/UI, and rendering component may not be visible in the foreground window/UI of the apparatus 200. For example, a webpage ‘webpage1.com’ is opened and a video from the webpage1.com is downloaded/played back, but it is not viewed/accessed at the display of the user interface 206. State of such rendering component is termed as the background state.

Further, even in the foreground UI/window, the rendering component may be in visible state or in invisible state, at any instance. For instance, the ‘file1.ppt’ is in the foreground state, and the ‘file1.ppt’ contains 20 slides including slide1-slide20. If the slide 9 of the ‘file1.ppt’ is displayed at the display of the user interface 206, the slide 9 may be considered in visible state, while other slides may be considered as in invisible state. In other example, if a web page is currently being accessed, the portion of the web page that is currently displayed at the UI 206 may be considered in visible state and the portion of the web page that is not visible may be considered in invisible state. In an example embodiment, if the rendering component is launched for the first time, the state of the rendering component may be the foreground UI/window and visible state.

In an example embodiment, the apparatus 200 is caused to determine at least a status of hardware rendering resources in the apparatus 200. In an example embodiment, examples of the hardware rendering resources may include a graphic processing unit including a graphic memory that is utilized for the hardware rendering of the content, or a hardware memory accessed by the processor 202 for performing the hardware rendering. An example of the hardware memory may include, but is not limited to, a graphic memory contained in the GPU. In some example embodiments, the memory 204 or any other memory accessible to the apparatus 200 may be an example of the hardware memory. In an example embodiment, the status of the hardware rendering resources includes availability status of the hardware rendering recourses present in the apparatus 200, or accessed/controlled by the apparatus 200. For example, at an instance, it may be determined that 30 mega byte (MB) of the graphic memory or the memory 204 is available that may be utilized by the rendering component for facilitating hardware rendering of the content associated with the rendering component.

In an example embodiment, the apparatus 200 along with the memory 204 and other components cause the apparatus 200 to facilitate the hardware rendering or the software rendering of content associated with the rendering component based at least in part on the state of the rendering component and the status of the hardware rendering resources. In an example embodiment, the processor 202 along with other components and memory 204 is configured to cause the apparatus 200 to perform hardware rendering if required amount of hardware rendering resources is available for performing the hardware rendering of the content, and if the state of the rendering component is in the foreground state and in the visible state. In some example embodiments, if the required amount of the hardware rendering resources is not available for performing the hardware rendering of the content, or if the state of the rendering component is in the background state or in the invisible state, the apparatus 200 may be caused to facilitate the software rendering of the content. However, in some example embodiments, if the state of the rendering component is in the foreground state and even if it is not in the visible state, the hardware rendering may be facilitated.

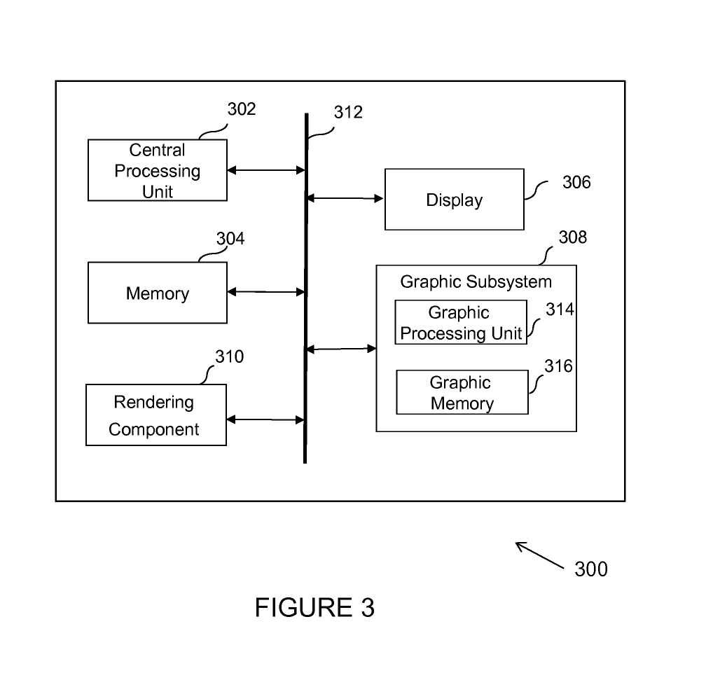

In some example embodiments, the apparatus 200 is caused to determine events such as state changes for the rendering components, and is caused to facilitate one of the hardware rendering or the software rendering. For example, if at an instant (t=0 second) any rendering component is rendering the content in the software rendering and the state of the rendering component is in the background state, and if at a next instant (t=2 second) the state of the rendering component is changed to the foreground state and the visible state, the apparatus 200 may be caused to facilitate the hardware rendering of the content if the required amount of graphic rendering resources is available. Various embodiments of managing the rendering of the content associated with rendering components are further described in FIGS. 3 to 5.

FIG. 3 illustrates an apparatus for managing rendering of content in accordance with another example embodiment. The apparatus 300 may be employed, for example, in the device 100 of FIG. 1. However, it should be noted that the apparatus 300, may also be employed on a variety of other devices both mobile and fixed, and therefore, embodiments should not be limited to application on devices such as the device 100 of FIG. 1. It should be noted that some devices or elements described below may not be mandatory and thus some may be omitted in certain embodiments.

The apparatus 300 includes a CPU 302, a memory 304, a display 306, a graphic subsystem 308, and at least one rendering component such as a rendering component 310. These components (302-310) may communicate to each other via a centralized circuit system 312 to perform rendering of the content. The centralized circuit system 312 may be various devices configured to, among other things, provide or enable communication between the components (302-310) of the apparatus 300. In certain embodiments, the centralized circuit system 312 may be a central printed circuit board (PCB) such as a motherboard, main board, system board, or logic board. The centralized circuit system 312 may also, or alternatively, include other printed circuit assemblies (PCAs) or communication channel media.

The central processing unit 302 may be an example of the processor 202 or the controller 108. The memory 304 may be an example of the memory 204. The display device 306 may be an example of the display of the UI 206. In an example embodiment, the graphic subsystem 308 may include a graphic processing unit (GPU) 314 and a graphic memory 316. In an example embodiment, the graphic subsystem 308 may be a graphic/video card that may be coupled with or integrated in the apparatus 300, or otherwise accessible to the apparatus 300. In certain example embodiments, the graphic subsystem 308 may be integrated along with the CPU 302. For instance, the CPU 302 and the graphic subsystem 308 may be integrated on a single motherboard, or a printed circuit board, or die.

The GPU 314 may interface with the CPU 302 by means of an expansion slot such as peripheral component interconnect (PCI) slot, PCI express (PCIe), or accelerated graphics port (AGP). In certain example embodiments, the graphic subsystem 308 may have the graphic memory 316 that may be configured by a RAM. In the example embodiments in which the GPU 314 is integrated with the CPU 302 such as in an integrated graphics solutions or shared graphics solutions, the graphic memory 316 may not be present and the memory 304 or any other shared memory may be utilized by the GPU 314. In certain example embodiments, there may be a cache memory that may be accessed by the GPU 314 for performing the hardware rendering of the content.

The rendering component 310 may be a software program or middleware component configured for generating an image from a scene file by means of computer programs. In FIG. 3, only a single rendering component 310 is shown, however, there may be plurality of such components may be present or otherwise accessible to the apparatus 300. The rendering component 310 may be accurately represented as separate entities in some embodiments as software programs and/or middleware components, and in other embodiments, the rendering component 310 may be embodied into the CPU 302 and/or the.GPU 314. In some example embodiments, the rendering component 310 may not be present in the apparatus 300, and may be accessed from external sources while the apparatus 300 accesses content from the external sources. For instance, if the apparatus 300 accesses a web page or external server for any content, the apparatus 300 may coordinate with rendering component(s) present at the webpage or the external sever. The scene file may contain information of features such as geometry, viewpoint, texture, lighting, and shading information as a description of a virtual scene. The data contained in the scene file is accessed by the rendering component 310. In an example embodiment, the scene file is processed by the rendering component 310 utilizing CPU 302 or the GPU 314 for facilitating software rendering or the hardware rendering, respectively, and outputs a digital image or raster graphics image file.

In an example embodiment, the CPU 302 or any other processing elements, along with other components may be configured to determine the state of the rendering component 310. For instant, the CPU 302 along with other components may determine the state of the rendering component 310 as at least one of the new launched, foreground state, background state, visible state and the invisible state. In an example embodiment, the new launched state may be same as the visible state. In an example embodiment, the CPU 302 along with other components may also be configured to determine status of the hardware rendering resources such as the graphic memory 316. In some example embodiments, the rendering component 310 may query the GPU 314 for the available amount of graphic memory 316 that can be utilized for the hardware rendering.

In an example embodiment, if the rendering component 310 is launched (started), the rendering component 310 receives information about the available amount of the graphic memory 316. In an example embodiment, the rendering component 310 also determines the required amount of the graphic memory 316 for facilitating the hardware rendering of the content associated with the rendering component 310. In an example embodiment, the rendering component 310 facilitates hardware rendering of the content if the required amount of the graphic memory 316 is available. In an example embodiment, the rendering component 310 facilitates the hardware rendering utilizing the GPU 314. In an example embodiment, the rendering component 310 facilitates software rendering of the content if the required amount of the graphic memory 316 is not available. In an example embodiment, the rendering component 310 facilitates the software rendering utilizing the CPU 302. In an example embodiment, the rendering component 310 is configured to receive notification of the availability of the required amount of the graphics memory 314. In an example embodiment, the rendering component 310 may receive the notification from the GPU 314. In an example embodiment, upon receiving the notification of the availability of the required amount of the graphic memory 316, the rendering component 310 may switch to the HW rendering of the content.

In an example embodiment, the rendering component 310 is configured to support switching from rendering content between the hardware rendering to the software rendering at any point of time in a seamless manner. For instance, if there is any event that causes change of state of the rendering component 310, the apparatus 300 is caused the determine whether the existing rendering method, for example the hardware rendering or the software rendering should be continued or switched to other rendering method. For example, if the rendering component 310 attains invisible state from the visible state, but is part of foreground app/UI element, the rendering component 310 may start facilitating software rendering from the hardware rendering. In some example embodiment, if the rendering component 310 switches to the software rendering from the hardware rendering, the rendering component 310 also releases some or entire amount of the graphic memory 316 utilized by the rendering component 310 at the moment. Such released amount of the graphic memory 316 may be utilized by newer rendering components that are in the visible state. For example, if a rendering component such as a flash plugin in a web browser becomes invisible (comes into the invisible state), the flash plugin releases any portion of the graphic memory 316 utilized by the flash plugin. Further, other flash plugins on the web page that become visible (comes into the visible state) as a result of events such as scrolling the webpage, may gain access of the hardware memory 314 on the basis of the available graphic memory 316 and required amount of graphic memory 316, at the instance.

In an example embodiment, if there is any event that causes the rendering component 310 to be visible again, the rendering component 310 may request for a notification from the GPU 314 for whether the required amount of the graphics memory 314 is present or not. In an example embodiment, once the notification is received, the rendering component 310 may switch to the hardware rendering. Further, on event where the rendering component attains the background state, the rendering component 310 may switch to the software rendering. Further, if at any instance, while the hardware rendering is facilitated by the rendering component 310, the requirement of the graphic memory 316 increases for the rendering component 310 and the increased amount of graphic memory is not available, the rendering component 310 may switch to facilitating content by the software rendering. For example, a web page is being scrolled and is rendered via the hardware rendering, and if at an instance, a video content present on the web page is played, the rendering component 310 may switch to the software rendering. In an example embodiment, if the rendering component 310 is configured to determine a change in the required amount of the hardware rendering resources for performing the hardware rendering of the content. In an example embodiment, the rendering component 310 may switch rendering between the hardware rendering and the software rendering based on the change in the required amount, present state of the rendering component and the availability status of the hardware rendering resources.

In various example embodiments, an apparatus such as the apparatus 200 and/or 300 may comprise various components such as means for managing rendering of content in the apparatus. Such components may be configured by utilizing hardware, firmware and software components. In an example embodiment, the apparatus may comprises means for determining at least a state of a rendering component in an apparatus, means for determining at least a status of hardware rendering resources in the apparatus, and means for facilitating a hardware rendering or a software rendering of content associated with the rendering component based at least in part on the state of the rendering component and the status of the hardware rendering resources. Examples of the means for managing rendering of the content may include the apparatuses 200 or 300, which may be an example of the controller 108.

In an example embodiment, the means for facilitating may comprises means for determining a required amount of the hardware rendering resources for performing the hardware rendering of the content, means for checking whether the required amount is available based on the availability status of the hardware rendering resources, and means for performing the hardware rendering of the content if the state of the rendering component is foreground state and visible state and if the required amount is available. Such means for facilitating may also comprises means for performing the software rendering of the content if the state of the rendering component is at least one of the background state and invisible state and means for performing the software rendering of the content if the required amount is unavailable. In an example embodiment, the apparatus may also comprise means for releasing at least in part the hardware rendering resources utilized by the rendering component if the state of the rendering component is changed from the visible state to the invisible state or the background state. Examples of such means may include the apparatuses 200 or 300, which may be an example of the controller 108.

In an example embodiment, the apparatus may also comprise means for determining if the required amount of the hardware rendering resources is available for performing the hardware rendering of the content, means for notifying the rendering component of the availability of the required amount of the hardware rendering resources, means for means for facilitating the hardware rendering of the content associated with the rendering component if the state of the rendering component is the visible state. In an example embodiment, the apparatus may also comprise means for determining a change in the required amount of the hardware rendering resources for performing the hardware rendering of the content and means for means for switching between the hardware rendering and the software rendering based on the change in the required amount, present state of the rendering component and the availability status of the hardware rendering resources. Examples of such means may include the apparatuses 200 or 300, which may be an example of the controller 108.

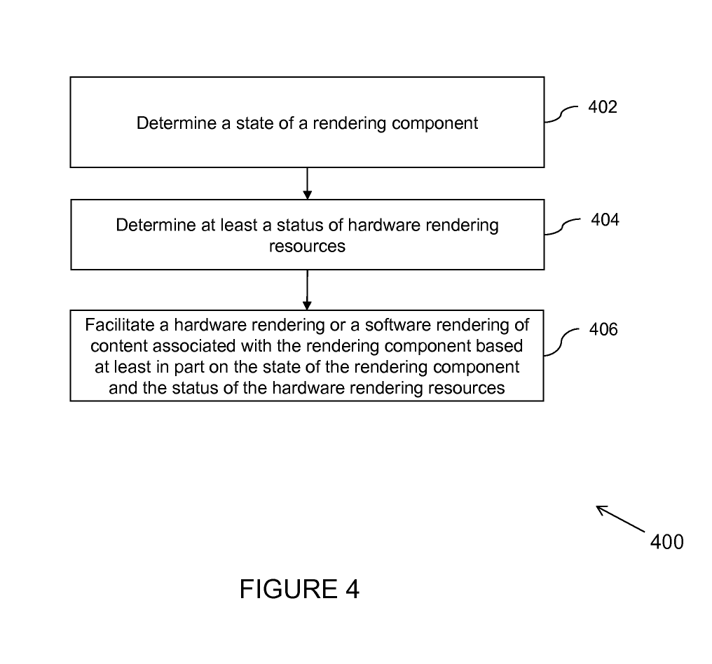

FIG. 4 is a flowchart depicting an example method 400 for managing rendering of content in an apparatus in accordance with an example embodiment. The method 400 depicted in flow chart may be executed by, for example, the apparatuses 200 or 300. It may be understood that for describing the method 400, references herein may be made to FIGS. 1-3.

At block 402, the method 400 includes determining at least a state of a rendering component. As described in FIG. 2, the state of the rendering component may be at least one of the foreground state, background state, visible state and the invisible state. At block 404, the method 400 includes determining at least a status of hardware rendering resources. In an example embodiment, the status of the hardware rendering resource may include availability status of the hardware rendering resources for performing the hardware rendering of the content associated with the rendering component.

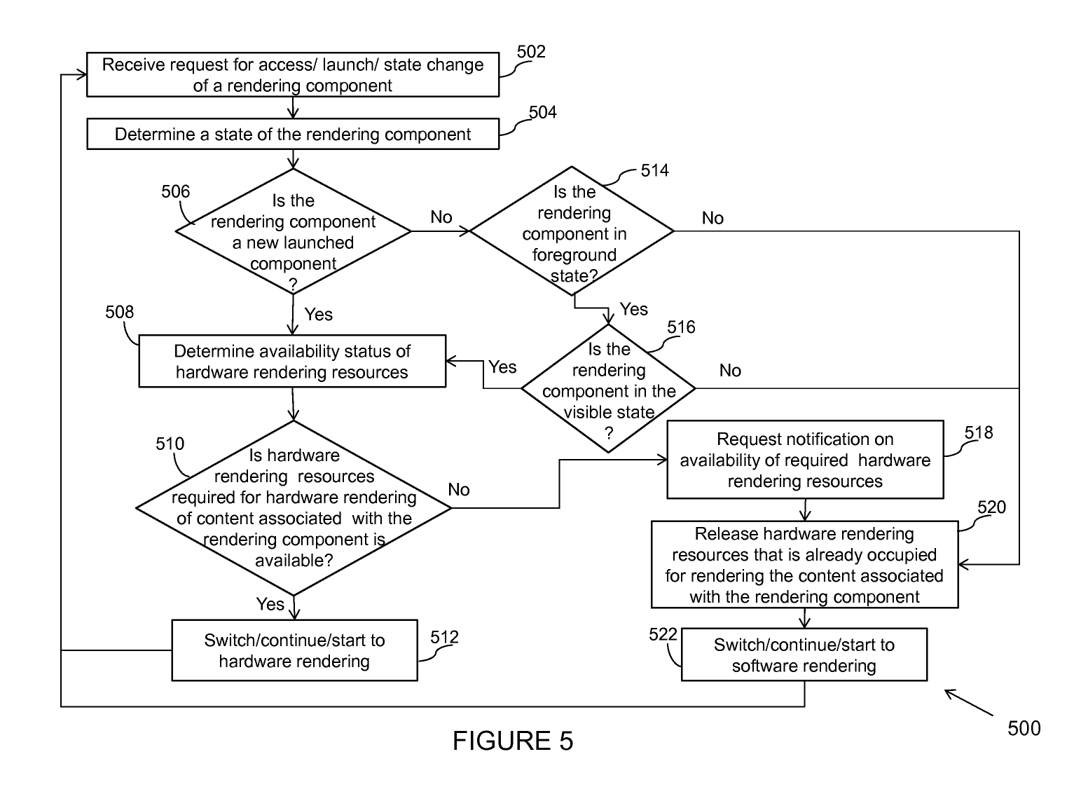

At block 406, the method 400 includes facilitating a hardware rendering or a software rendering of content based at least in part on the state of the rendering component and the status of the hardware rendering resources. In an example embodiment, facilitating comprises determining a required amount of hardware rendering resources for performing the hardware rendering of the content. In an example embodiment, it is checked whether the required amount of the hardware rendering resources is available based on the determined availability status of the hardware rendering resources. In an example embodiment, hardware rendering of the content is facilitated if the state of the rendering component is the foreground state and the visible state and if the required amount of the hardware rendering resources is available. In an example embodiment, software rendering of the content is facilitated if the state of the rendering component is in the background state or in invisible state, or if the required amount of the hardware rendering resources is unavailable. Various embodiments of managing rendering of the content are further described in FIG. 5.

FIG. 5 is a flowchart depicting an example method 500 for managing rendering of content associated with rendering components in an apparatus in accordance with an example embodiment. The method 500 depicted in flow chart may be executed by, for example, the apparatuses 200 or 300. It may be understood that for describing the method 500, references herein may be made to FIGS. 1-3. It should be noted that that although the method 500 of FIG. 5 shows a particular order, the order need not be limited to the order shown, and more or fewer blocks may be executed, without providing substantial change to the scope of the various example embodiments.

At 502, the method 500 includes receiving request for accessing or launch of a rendering component in the apparatus such as the apparatuses 200 or 300. As described in FIG. 2, the rendering components may be any software program/instructions, tools or middleware components utilized for displaying any content such as video, graphics, animation, audio-visual content, image, and the like. In an example embodiment, accessing the rendering component may include accessing content associated with the rendering component. For example, accessing a flash plugin rendering component results into accessing/displaying content such as graphics, animations and audio. In another example, rendering component such as web browser may be launched to access a webpage. Herein, accessing the web browser may include scrolling over the web page to display text, images and videos present and/or linked to the web page.

At 504, the method 500 includes determining state of the rendering component. In an example embodiment, the state of the rendering component may include a launch state, a foreground state and background state. In an example embodiment, rendering components running in the background state may be in invisible state, and the rendering component running in the foreground state may be one of the visible state or in the invisible state. In an example embodiment, the launch state of the rendering component may be same as the visible state.

At 506, it is checked whether the rendering component is a new launched rendering component. For instance, if the rendering component the new launched rendering component (for example, the state of the rendering component is the ‘launch state’) which suggests that the rendering component has not started software rendering or the hardware rendering of the content associated with the rendering component. If the rendering component is the new launched rendering component, the method 500 proceeds to 508. At 508, availability status of hardware rendering resources is determined In an example embodiment, the availability status of the hardware rendering resources may include amount of the hardware rendering resources, such as the graphic memory that may be available for performing the hardware rendering of the content associated with the rendering component. For instance, the graphic memory in the apparatus may have a capacity of 256 MB, and if 170 MB of the graphic memory is utilized for hardware rendering by the existing rendering components, only 86 MB is the available memory that may be utilized for the hardware rendering by the rendering component.

At 510, it is checked whether hardware rendering resources required for facilitating the hardware rendering of the content is available based on the availability status of the hardware rendering resources. In an example embodiment, a required amount of the hardware rendering resources for performing the hardware rendering of the content is determined For instance, it may be determined that in order to perform the hardware rendering of the content associated with the rendering component, the required amount is 40 MB. In an example embodiment, the required amount is compared with the available amount of the hardware rendering resources (of the graphic memory that is 80 MB). In an example embodiment, if it is determined that the required amount of the graphic memory is available, the method 500 proceeds to 512.

At 512, the method 500 includes performing hardware rendering of the content associated with the rendering component. In an example embodiment, the hardware rendering is performed by utilizing the hardware rendering resources (for example, the graphic subsystem 308, or the processor 202 having the functionalities of the graphic subsystem 308).

In an example embodiment, if at block 510, it is checked that the required amount of the hardware rendering resources is not available, the method 500 may proceed to block 518. For instance, if the graphic memory required for the hardware rendering of the rendering component is 120 MB, and the available graphic memory is only 80 MB, it is checked that the required amount of memory is not available. At block 518, in an example embodiment, the method 500 includes requesting for a notification for the availability of the required amount of the graphic memory. At block 520, in an example embodiment, if the rendering component has already occupied some graphic memory, the already occupied graphic memory is released and method 500 proceeds to 522.

At block 522, the method 500 includes performing software rendering of the content associated with the rendering component. In an example embodiment, if a notification is received that the required amount of hardware rendering recourse becomes available, the hardware rendering of the content may be facilitated. In such instances, the software rendering for the content is switched to the hardware rendering if a notification is received such that the required amount of the hardware rendering resources is available. In some example embodiments, if it determined that the required amount of the hardware rendering resources is not available, the method 500 may proceed directly to block 522 instead of block 518, from the block 510.

Referring again to block 506, if it determined that rendering component is a running component (already launched), it is further checked whether the rendering component is in the foreground state, at block 514. In an example embodiment, at block 514, if it is determined that the rendering component is not in the foreground state (for example the rendering component is in the background state), the method proceed to block 520. In another example embodiment, upon determination of the rendering component not being in the foreground state, the method 500 may directly proceed to block 522, and the software rendering of the content may be facilitated.

At block 514, if it is determined that the rendering component is in the foreground state, it is further determined whether the rendering component is in the visible state or not at block 516. If is determined that the rendering component is not in the visible state (for example in the invisible state), the method 500 may proceed to block 520, in an example embodiment. In another example embodiment, the method 500 may directly proceed to block 522 and the software rendering of the content associated with the rendering component is facilitated.

At block 516, if it is determined that the rendering component is in the visible state, the method proceeds to block 508, where availability status of the hardware rendering resources is determined If it is determined that the required amount of the hardware rendering resources is available at 510, the hardware rendering of the content is facilitated at block 512. If it is determined that the required amount of the hardware rendering resources is unavailable, the method proceeds to the block 518. At block 518, the method 500 includes requesting for the notification for the availability of the required amount of the graphic memory. At block 520, in an example embodiment, if the rendering component has already occupied some graphic memory, the already occupied graphic memory is released and method 500 proceeds to 522. In another example embodiment, if it is determined that the required amount of the hardware rendering resources is unavailable, the method 500 may directly proceed to the block 522 from the block 510 to facilitate software rendering of the content associated with the rendering component.

In an example embodiment, while the operations of the block 512 or 522 are performed, the method 500 is configured to detect any events such as closure of the rendering component, change of state of the rendering component, and the method 500 may further determine whether the existing rendering method such as the software rendering or the hardware rendering should be continued for the rendering the content or should be changes. For example, considering that the hardware rendering of the content associated with the rendering component “flash plugin” is performed, and at an instance, if the window/UI in which the flash plugin component is operating is sent to the background state (for example, the window is no longer used as a foreground application), a change of state for the flash plugin is determined In such case, as it is determined that the flash plugin has changed its state from visible state to the background state (or the invisible state), the hardware rendering is switched to the software rendering for rendering the content associated with the flash plugin.

In some example embodiments, if the requirement of the hardware rendering resources increases or decreases, the existing rendering method such as the hardware rendering or the software may be switched to other rendering method depending upon the change in the required amount, present state of the rendering component and the availability status of the hardware rendering resources. For example, if a rendering component in visible state performs the software rendering due to unavailability of the hardware rendering resources, and if the required amount for the hardware rendering of the content decrease such that new required amount is less than the available amount of the hardware rendering resources at the moment, the method 500 includes switching to the hardware rendering from the software rendering. Further, if a rendering component is performing the hardware rendering for the content and the requirement of the hardware rendering resources increases such that the increased hardware rendering resources is not available, in such cases, the method 300 includes switching to the software rendering from the hardware rendering.

Operations of the flowcharts 400 or 500, and combinations of operations in the flowcharts 400 or 500, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowcharts 400 or 500. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the methods 400 and 500 are described with help of the apparatuses 200 or 300. However, the operations of the methods 400 and 500 can be described and/or practiced by using any other apparatus.

Without in any way limiting the scope, interpretation, or application of the claims appearing below, a technical effect of one or more of the example embodiments disclosed herein is to managing rendering of content in an apparatus. Various embodiments provide methods for optimizing the usage of the hardware rendering resources such that the visible rendering components get access of the hardware rendering resources. Various embodiments provide seamless switching between the hardware rendering and the software rendering at any events such as state changes of the rendering components.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

We claim:

1. A method comprising:
determining at least a state of a rendering component;
determining at least a status of hardware rendering resources; and
facilitating a hardware rendering or a software rendering of content associated with the rendering component based at least in part on the state of the rendering component and the status of the hardware rendering resources.

2. The method as claimed in claim 1, wherein determining the status of the hardware rendering resources comprises determining availability status of the hardware rendering resources for facilitating the hardware rendering of the content.

3. The method as claimed in claim 2, wherein the facilitating comprises:
determining a required amount of the hardware rendering resources for performing the hardware rendering of the content;
checking whether the required amount is available based on the availability status of the hardware rendering resources; and
performing the hardware rendering of the content if the required amount is available and if the state of the rendering component is a foreground state or a visible state.

4. The method as claimed in claim 1, wherein the facilitating further comprises:
performing the software rendering of the content if the state of the rendering component is a background state, if the state of the rendering component is an invisible state, or if a required amount of the hardware rendering resources for performing the hardware rendering of the content is unavailable.

5. The method as claimed in claim 3, further comprising:
releasing at least in part the hardware rendering resources utilized by the rendering component if the state of the rendering component is changed from the visible state to an invisible state or if the state of the rendering component is changed from the foreground state to a background state.

6. The method as claimed in claim 4, further comprising:
determining if the required amount of hardware rendering resources is available for performing the hardware rendering of the content;
notifying the rendering component of the availability of the required amount of the hardware rendering resources; and
facilitating the hardware rendering of the content associated with the rendering component if the state of the rendering component is the visible state.

7. The method as claimed in claim 3, further comprising:
determining a change in the required amount of the hardware rendering resources for performing the hardware rendering of the content; and
switching between the hardware rendering and the software rendering based on one or more of the change in the required amount, present state of the rendering component and the availability status of the hardware rendering resources.

8. An apparatus comprising:
at least one processor; and
at least one memory comprising computer program code, the at least one memory and the computer program code configured to, with the at least one processor, cause the apparatus at least to perform:
determine at least a state of a rendering component;
determine at least a status of hardware rendering resources; and
facilitate a hardware rendering or a software rendering of content associated with the rendering component based at least in part on the state of the rendering component and the status of the hardware rendering resources.

9. The apparatus as claimed in claim 8, wherein the state of the rendering component comprises one or more of a foreground state, a background state, a visible state and an invisible state.

10. The apparatus as claimed in claims 9, wherein the apparatus is further caused, at least in part, to perform: determine the status of the hardware rendering resources by determining availability status of the hardware rendering resources for facilitating the hardware rendering for the content.

11. The apparatus as claimed in claim 10, wherein the apparatus is further caused, at least in part, to perform:
determine a required amount of the hardware rendering resources for performing the hardware rendering of the content;
check whether the required amount is available based on the availability status of the hardware rendering resources; and
perform hardware rendering of the content if the required amount is available and if the state of the rendering component is the foreground state or the visible state.

12. The apparatus as claimed in claim 9, wherein the apparatus is further caused, at least in part, to perform:
software rendering of the content if the state of the rendering component is the background state, if the state of the rendering component is invisible state, or if a required amount of the hardware rendering resources for performing the hardware rendering of the content is unavailable.

13. The apparatus as claimed in claims 11, wherein the apparatus is further caused, at least in part, to perform:
release at least in part the hardware rendering resources utilized by the rendering component if the state of the rendering component is changed from the visible state to the invisible state or if the state of the rendering component is changed from the foreground state to the background state.

14. The apparatus as claimed in claims 12, wherein the apparatus is further caused, at least in part, to perform:
determine if the required amount of hardware rendering resources is available for performing the hardware rendering of the content;
notify the rendering component of the availability of the required amount of the hardware rendering resources; and
facilitate the hardware rendering of the content associated with the rendering component if the state of the rendering component is the visible state.

15. The apparatus as claimed in claim 3, wherein the apparatus is further caused, at least in part, to perform:
determine a change in the required amount of the hardware rendering resources for performing the hardware rendering of the content; and
switch between the hardware rendering and the software rendering based on the change in the required amount, present state of the rendering component and the availability status of the hardware rendering resources.

16. A computer program product comprising at least one computer-readable storage medium, the computer-readable storage medium comprising a set of instructions, which, when executed by one or more processors, cause an apparatus at least to perform:
determine at least a state of a rendering component;
determine at least a status of hardware rendering resources; and
facilitate a hardware rendering or a software rendering of content associated with the rendering component based at least in part on the state of the rendering component and the status of the hardware rendering resources.

17. The computer program product as claimed in claims 16, wherein the apparatus is further caused, at least in part, to perform:
determine a required amount of the hardware rendering resources for performing the hardware rendering of the content;
check whether the required amount is available based on availability status of the hardware rendering resources; and
perform hardware rendering of the content if the state of the rendering component is a foreground state and a visible state and if the required amount is available.

18. The computer program product as claimed in claim 16, wherein the apparatus is further caused, at least in part, to perform:
software rendering of the content if the state of the rendering component is a background state, if the state of the rendering component is an invisible state, or if a required amount of the hardware rendering resources for performing the hardware rendering of the content is unavailable.

19. The computer program product as claimed in claim 17, wherein the apparatus is further caused, at least in part, to perform:
release at least in part the hardware rendering resources utilized by the rendering component if the state of the rendering component is changed from the visible state to the invisible state or if the state of the rendering component is changed from the foreground state to a background state.

20. The computer program product as claimed in claim 19, wherein the apparatus is further caused, at least in part, to perform:
determine if the required amount of the hardware rendering resources is available for performing the hardware rendering of the content;
notify the rendering component of the availability of the required amount of the hardware rendering resources; and
facilitate the hardware rendering of the content associated with the rendering component if the state of the rendering component is the visible state.
